(19) United States
(12) Patent Application Publication
(10) Pub. No.: US 2007/0233679 A1
(43) Pub. Date: Oct. 4, 2007

(54) LEARNING A DOCUMENT RANKING FUNCTION USING QUERY-LEVEL ERROR MEASUREMENTS

(75) Inventors: Tie-Yan Liu, Beijing (CN); Tao Qin, Beijing (CN); Wei-Ying Ma, Beijing (CN)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/278,508

(22) Filed: Apr. 3, 2006

(51) Int. Cl. G06F 7/00

(52) U.S. Cl. 707/7

(57) ABSTRACT

A method and system for learning a ranking function that uses a normalized, query-level error function is provided. A ranking system learns a ranking function using training data that includes, for each query, the corresponding documents and, for each document, its relevance to the corresponding query. The ranking system uses an error calculation algorithm that calculates an error between the actual relevances and the calculated relevances for the documents of each query. The ranking system normalizes the errors so that the total errors for each query will be weighted equally. The ranking system then uses the normalized error to learn a ranking function that works well for both queries with many documents in their search results and queries with few documents in their search results.

### BACKGROUND

Many search engine services, such as Google and Overture, provide for searching for information that is accessible via the Internet. These search engine services allow users to search for display pages, such as web pages, that may be of interest to users. After a user submits a search request (i.e., a query) that includes search terms, the search engine service identifies web pages that may be related to those search terms. To quickly identify related web pages, the search engine services may maintain a mapping of keywords to web pages. This mapping may be generated by “crawling” the web (i.e., the World Wide Web) to identify the keywords of each web page. To crawl the web, a search engine service may use a list of root web pages to identify all web pages that are accessible through those root web pages. The keywords of any particular web page can be identified using various well-known information retrieval techniques, such as identifying the words of a headline, the words supplied in the metadata of the web page, the words that are highlighted, and so on. The search engine service identifies web pages that may be related to the search request based on how well the keywords of a web page match the words of the query. The search engine service then displays to the user links to the identified web pages in an order that is based on a ranking that may be determined by their relevance to the query, popularity, importance, and/or some other measure.

The success of the search engine service may depend in large part on its ability to rank web pages in an order that is most relevant to the user who submitted the query. Search engine services have used many machine learning techniques in an attempt to learn a good ranking function. The learning of a ranking function for a web-based search is quite different from traditional statistical learning problems such as classification, regression, and density estimation. The basic assumption in traditional statistical learning is that all instances are independently and identically distributed. This assumption, however, is not correct for web-based searching. In web-based searching, the rank of a web page of a search result is not independent of the other web pages of the search result, but rather the ranks of the web pages are dependent on one another.

Several machine learning techniques have been developed to learn a more accurate ranking function that factors in the dependence of the rank of one web page on the rank of another web page. For example, a RankSVM algorithm, which is a variation of a generalized Support Vector Machine (“SVM”), attempts to learn a ranking function that preserves the pairwise partial ordering of the web pages of training data. A RankSVM algorithm is described in Joachims, T., “Optimizing Searching Engines Using Clickthrough Data,” Proceedings of the ACM Conference on Knowledge Discovery and Data Mining (“KDD”), ACM, 2002. Another example of a technique for learning a ranking function is a RankBoost algorithm. A RankBoost algorithm is an adaptive boosting algorithm that, like a RankSVM algorithm, operates to preserve the ordering of pairs of web pages. A RankBoost algorithm is described in Freund, Y., Iyer, R., Schapire, R., and Singer, Y., “An Efficient Boosting Algorithm for Combining Preferences,” Journal of Machine Learning Research, 2003(4). As another example, a neural network algorithm, referred to as RankNet, has been used to rank web pages. A RankNet algorithm also operates to preserve the ordering of pairs of web pages. A RankNet algorithm is described in Burges, C., Shaked, T., Renshaw, E., Lazier, A., Deeds, M., Hamilton, N., and Hullender, G., “Learning to Rank Using Gradient Descent,” 22nd International Conference on Machine Learning, Bonn, Germany, 2005.

These machine learning techniques attempt to learn a ranking function by operating on document (e.g., web page) pairs to minimize an error function between these pairs. In particular, these techniques learn a ranking function that will correctly rank as many document pairs as possible. The objective of correctly ranking as many document pairs as possible will not in general, however, lead to an accurate ranking function. For example, assume that two queries q₁ and q₂ have 40 and 5 documents, respectively, in their search results. A complete pairwise ordering for query q₁ will specify the ordering for 780 pairs, and a complete pairwise ordering for query q₂ will specify the ordering for 10 pairs. Assume the ranking function can correctly rank 780 out of the 790 pairs. If 770 pairs from query q₁ and the 10 pairs from query q₂ are correctly ranked, then the ranking function will likely produce an acceptable ranking for both queries. If, however, 780 pairs from query q₁ are ranked correctly, but no pairs from query q₂ are ranked correctly, then the ranking function will produce an acceptable ranking for query q₁, but an unacceptable ranking for query q₂. In general, the learning technique will attempt to minimize the total error for pairs of documents across all queries by summing the errors for all pairs of documents. As a result, the ranking function will be more accurate at ranking queries with many web pages and less accurate at ranking queries with few web pages. Thus, these ranking functions might only produce acceptable results if all the queries of the training data have approximately the same number of documents. It is, however, extremely unlikely that a search engine would return the same number of web pages in the search results for a collection of training queries.

### SUMMARY

A method and system for learning a ranking function that uses a normalized, query-level error function is provided. A ranking system learns a ranking function using training data that includes, for each query, the corresponding documents and, for each document, its relevance to the corresponding query. The ranking system uses an error calculation algorithm that calculates an error between the actual relevances and the calculated relevances for the documents of each query, rather than summing the errors of each pair of documents across all queries. The ranking system normalizes the errors so that the total errors for each query will be weighted equally. The ranking system then uses the normalized error to learn a ranking function that works well for both queries with many documents in their search results and queries with few documents in their search results.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram that illustrates components of the ranking system in one embodiment.

FIG. 2 is a flow diagram that illustrates the processing of the error calculation component of the ranking system in one embodiment.

FIG. 3 is a flow diagram that illustrates the processing of the rank cosine component of the ranking system in one embodiment.

FIG. 4 is a flow diagram that illustrates the processing of the evaluate weak learners component of the ranking system in one embodiment.

FIG. 5 is a flow diagram that illustrates the processing of the calculate optimal alpha component of the ranking system in one embodiment.

FIG. 6 is a flow diagram that illustrates the processing of the calculate optimal alpha num component of the ranking system in one embodiment.

FIG. 7 is a flow diagram that illustrates the processing of the calculate optimal alpha den component of the ranking system in one embodiment.

FIG. 8 is a flow diagram that illustrates the processing of the calculate cosine error component of the ranking system in one embodiment.

FIG. 9 is a flow diagram that illustrates the processing of the cosine error component of the ranking system in one embodiment.

FIG. 10 is a flow diagram that illustrates the processing of the calculate W₁ component of the ranking system in one embodiment.

FIG. 11 is a flow diagram that illustrates the processing of the calculate W₁ num component of the ranking system in one embodiment.

FIG. 12 is a flow diagram that illustrates the processing of the calculate W den component of the ranking system in one embodiment.

FIG. 13 is a flow diagram that illustrates the processing of the calculate W₂ component of the ranking system in one embodiment.

FIG. 14 is a flow diagram that illustrates the processing of the calculate W₂ num component of the ranking system in one embodiment.

### DETAILED DESCRIPTION

A method and system for learning a ranking function that uses a normalized, query-level error function is provided. In one embodiment, the ranking system learns a ranking function using training data that includes, for each query, the corresponding documents and, for each document, its relevance to the corresponding query. For example, the ranking system may submit training queries to a search engine service and store the search results of the queries in a training store. The ranking system may then allow a user to indicate the actual relevance of each document to its corresponding query. The ranking system uses an error calculation algorithm that calculates an error between the actual relevances and the calculated relevances for the documents of each query, rather than summing the errors of each pair of documents across all queries. Such an error calculation algorithm produces a query-level error measurement. The ranking system also normalizes the errors so that the total errors for each query will be weighted equally. In other words, the normalized errors are independent of the number of documents of the search result of the query. In one embodiment, the ranking function represents the error measurement for a query as the cosine of the angle between vectors representing the actual relevances and the calculated relevances in an n-dimensional space, where n is the number of documents in the search result. In this way, the ranking system can learn a ranking function that works well for both queries with many documents in their search results and queries with few documents in their search results.

In one embodiment, the ranking system uses an adaptive boosting technique to learn a ranking function. The ranking system defines various weak learners and iteratively selects additional weak learners to add to the ranking function. During each iteration, the ranking system selects the weak learner that when added to the ranking function would result in the smallest aggregate error between the actual and calculated relevances calculated using a normalized error for each query of the training data. The ranking system selects a combination weight for each weak learner to indicate the relative importance of each weak learner to the ranking function. After each iteration, the ranking system also selects a query weight for each query so that during the next iteration the ranking system will focus on improving the accuracy for the queries that have a higher error. The ranking function is thus the combination of the selected weak learners along with their combination weights.

In one embodiment, the ranking system uses a cosine-based error function that is represented by the following equation:

$$J ( g ( q ) , H ( q ) ) = - cos ( g ( q ) , H ( q ) ) = - \frac{{g ( q )}^{T} H ( q )}{‖ g ( q ) ‖ ‖ H ( q ) ‖} \qquad ( 1 )$$

where J(g(q),H(q)) represents the normalized error for query q, g(q) represents a vector of actual relevances for the documents corresponding to query q, H(q) represents a vector of calculated relevances for the documents corresponding to query q, ∥ ∥ is the L-2 norm of a vector, and the dimension of the vectors is n(q), which represents the number of documents in the search result for query q. The absolute value of the relevance for each document is not particularly important to the accuracy of the learned ranking function, provided that the relevance of a more relevant document is higher than that of a less relevant document. Since the error function is cosine-based, it is also scale invariant. The scale invariance is represented by the following equation:
J(g(q),H(q))=J(g(q),λH(q)) (2)
where λ is any positive constant. Also, since the error function is cosine-based, its range can be represented by the following equation:
−1≦J(g(q),H(q))≦1 (3)
The ranking function combines the query-level error function into an overall training-level error function as represented by the following equation:

$$J ( H ) = {\sum }_{qε Q} J ( g ( q ) , H ( q ) ) \qquad ( 4 )$$

where J(H) represents the total error and Q represents the set of queries in the training data.

In one embodiment, the ranking system adopts a generalized additive model as the final ranking function as represented by the following equation:

$$H ( q ) = {\sum }_{t = 1}^{T} {α}_{t} {h}_{t} ( q ) \qquad ( 5 )$$

where αₜ is the combination weight of a weak learner, hₜ(q) is a weak learner that maps an input matrix (a row of this matrix is the feature of a document) to an output vector, and d is the feature dimension of a document. A weak learner maps the input matrix as represented by the following equation:
hₜ(q):R^{n(q)×d}→R^{n(q)} (6)
where n(q) is the number of documents in the search result of query q. The ranking system may normalize the actual relevances for each query as represented by the following equation:

$$g ( q ) = \frac{g ( q )}{‖ g ( q ) ‖} \qquad ( 7 )$$

When Equation 7 is substituted into Equation 1, the result is represented by the following equation:

$$J ( g ( q ) , H ( q ) ) ⩵ - \frac{g {( q )}^{T} H ( q )}{‖ H ( q ) ‖} \qquad ( 8 )$$

In one embodiment, the ranking system uses a stage-wise greedy search strategy to identify the parameters of the ranking function. The ranking function at each iteration can be represented by the following equations:

$$\begin{matrix}{H}_{k} ( q ) = {\sum }_{t = 1}^{k} {α}_{t} {h}_{t} ( q ) \\ or & ( 9 ) \\ {H}_{k} ( q ) = {H}_{k - 1} ( q ) + {α}_{k} {h}_{k} ( q ) & ( 10 )\end{matrix}$$

where Hₖ(q) represents the ranking function at iteration k and hₖ(q) is a weak learner for iteration k. Many different weak learners may be defined as candidates for selection at each iteration. For example, there may be a weak learner for each feature and its basic transformations (e.g., square, exponential, and logarithm). The total error of Hₖ(q) over all queries is represented by the following equation:

$$J ( {H}_{k} ) = - {\sum }_{q} \frac{{g ( q )}^{T} {H}_{k} ( q )}{‖ {H}_{k} ( q ) ‖} \qquad ( 11 )$$

Using Hₖ₋₁(q) and hₖ(q), Equation 11 can be represented by the following equation:

$$J ( {H}_{k} ) = - {\sum }_{q} \frac{{g}^{T} ( q ) ( {H}_{k - 1} ( q ) + {α}_{k} {h}_{k} ( q ) )}{\sqrt{{H}_{k - 1} ( q ) + {α}_{k} {{h}_{k} ( q )}^{T} ( {H}_{k - 1} ( q ) + {α}_{k} {h}_{k} ( q ) )}} \qquad ( 12 )$$

The ranking function represents the optimal weight (as derived by setting the derivative of Equation 12 with respect to αₖ to zero) for a weak learner by the following equation:

$${α}_{k} = \frac{{\sum }_{q} {W}_{1 , k}^{T} ( q ) {h}_{k} ( q )}{{\sum }_{q} {W}_{2 , k}^{T} ( q ) ( {h}_{k} ( q ) {g}^{T} ( q ) {h}_{k} ( q ) - g ( q ) {h}_{k}^{T} ( q ) {h}_{k} ( q ) )} \qquad ( 13 )$$

where W_{1,k}(q) and W_{2,k}(q) are two n(q)-dimension weight vectors as represented by the following equations:

$$\begin{matrix}{W}_{1 , k} ( q ) = \frac{( {g}^{T} ( q ) {H}_{k - 1} ( q ) {H}_{k - 1} ( q ) - {H}_{k - 1}^{T} ( q ) {H}_{k - 1} ( q ) g ( q ) )}{{‖ {H}_{k - 1} ( g ) ‖}^{3 / 2}} & ( 14 ) \\ {w}_{2 , k} ( q ) = \frac{{H}_{k - 1} ( q )}{{‖ {H}_{k - 1} ( q ) ‖}^{3 / 2}} & ( 15 )\end{matrix}$$

The ranking system uses Equations 12 and 13 to calculate the cosine error and the optimal combination weight αₖ for each weak learner candidate. The ranking function then selects the weak learner candidate with the smallest error as the k-th weak learner. By selecting a weak learner at each iteration, the ranking function identifies a sequence of weak learners together with their combination weights as the final ranking function. The ranking system uses a RankCosine adaptive boosting algorithm as represented by the pseudo-code of Table 1. In Table 1, e_{p(q)} is a n(q)-dimensional vector with all elements equal to 1.

TABLE 1
Algorithm: RankCosine
Given: actual relevances g(q) over Q, and weak learner candidates h, (q),
i = 1, 2, . . .
$Initialize \text{:} {W}_{1 , 1} ( q ) = {W}_{2 , 1} ( q ) = \frac{{e}_{n ( q )}}{n ( q )}$
For t = 1, 2, . . . , T

(a) For each weak learner candidate h, (q)

(a.1) Compute optimal α_{t,i} by Equation 13
(a.2) Compute the cosine loss ε_{t,i} by Equation 12

(b) Choose the weak learner h_{t,i} (q) with minimal loss as hₜ (q)
(c) Choose corresponding α_{t,i} as αₜ
(d) Update query weight vectors W_{1,k} (q) and W_{2,k} (q) by Equations
14 and 15

Output the final ranking function $H ( q ) = {\sum }_{t = 1}^{T} {α}_{t} {h}_{t} ( q )$

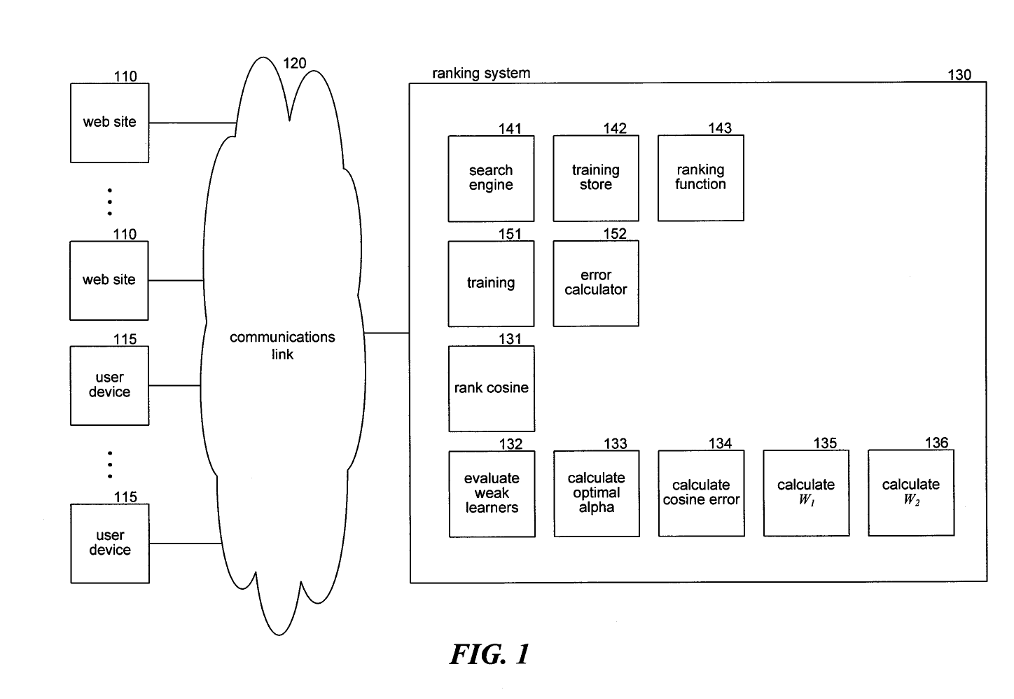

FIG. 1 is a block diagram that illustrates components of the ranking system in one embodiment. The ranking system 130 is connected via communications link 120 to web sites 110 and user devices 115. The ranking system may include a search engine 141, a training store 142, and a ranking function 143. The search engine may input queries of the training store, conduct searches for the queries, and store the search results in the training store. The ranking system may also represent web pages of the search results by feature vectors derived from the web pages. The ranking system may use a variety of features such as keywords, term frequency by inverse document frequency, and so on. The ranking function is generated by the ranking system to rank web pages returned by the search engine. The ranking system includes a training component 151 and an error calculation component 152. The training component may use any of a variety of learning techniques to learn the ranking function based on an error function as calculated by the error calculation component. In one embodiment, the ranking system uses a rank cosine component 131 to generate a ranking function. The rank cosine component uses an adaptive boost algorithm of Table 1 by invoking an evaluate weak learners component 132, a calculate optimal alpha (i.e., combination weight) component 133, a calculate cosine error component 134, a calculate W₁ component 135, and a calculate W₂ component 136.

The computing devices on which the ranking system may be implemented may include a central processing unit, memory, input devices (e.g., keyboard and pointing devices), output devices (e.g., display devices), and storage devices (e.g., disk drives). The memory and storage devices are computer-readable media that may contain instructions that implement the ranking system. In addition, the data structures and message structures may be stored or transmitted via a data transmission medium, such as a signal on a communications link. Various communications links may be used, such as the Internet, a local area network, a wide area network, or a point-to-point dial-up connection.

The ranking system may be implemented on various computing systems or devices including personal computers, server computers, multiprocessor systems, microprocessor-based systems, network PCs, minicomputers, mainframe computers, distributed computing environments that include any of the above systems or devices, and the like. The ranking system may also provide its services (e.g., ranking of search results using the ranking function) to various computing systems such as personal computers, cell phones, personal digital assistants, consumer electronics, home automation devices, and so on.

The ranking system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments. For example, the training component may be implemented on a computer system separate from the computer system that collects the training data or the computer system that using the ranking function to rank search results.

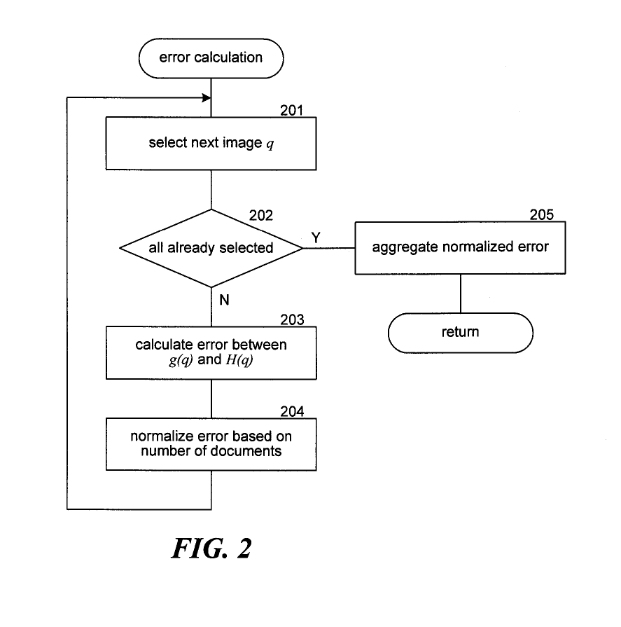

FIG. 2 is a flow diagram that illustrates the processing of the error calculation component of the ranking system in one embodiment. This component calculates the aggregate error between actual relevances and calculated relevances for all queries of the training data. In block 201, the component selects the next query. In decision block 202, if all the queries have already been selected, then the component continues at block 205, else the component continues at block 203. In block 203, the component calculates the error between the actual relevances and the calculated relevances for the selected query. In block 204, the component normalizes the error based on the number of documents within the search result of the selected query. The component then loops to block 201 to select the next query. In block 205, the component aggregates the normalized errors and returns the aggregated error.

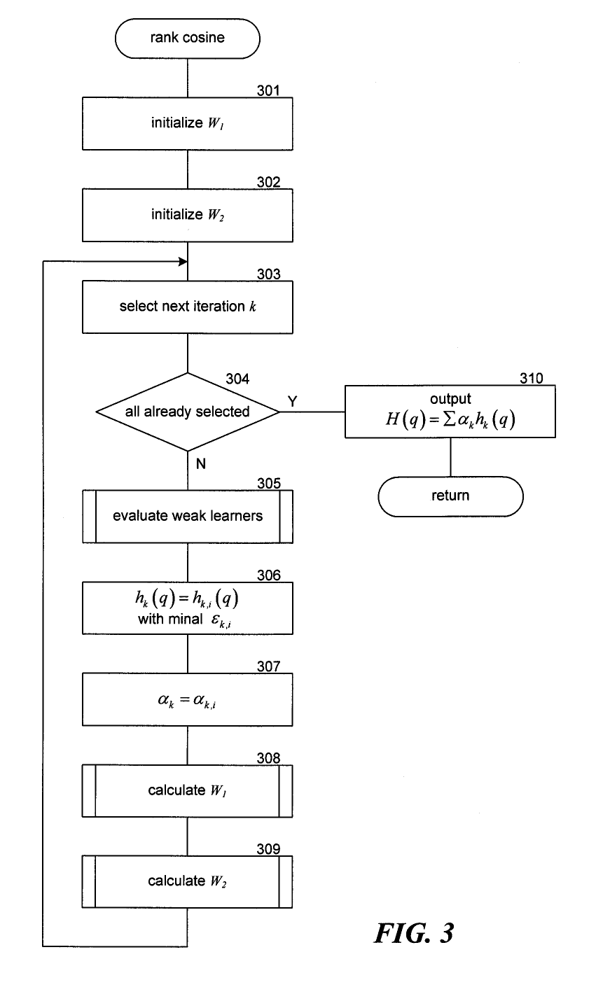

FIG. 3 is a flow diagram that illustrates the processing of the rank cosine component of the ranking system in one embodiment. The component implements the algorithm of Table 1. In block 301, the component initializes W₁. In block 302, the component initializes W₂. W₁ and W₂ represent query weights for each query indicating the queries' influence on selecting the next weak learner. The initial weights are equal for all queries. In block 303, the component starts the next iteration k. In decision block 304, if all the iterations have already been completed, then the component continues at block 310, else the component continues at block 305. In block 305, the component invokes the evaluate weak learners component to calculate an error for each weak learner that is a candidate to be added to the ranking function that has been generated so far. In block 306, the component selects the weak learner with the smallest error. In block 307, the component sets the combination weight for the selected weak learner. In block 308, the component invokes the calculate W₁ component. In block 309, the component invokes the calculate W₂ component. The W₁ and W₂ components calculate the query weights for the next iteration. The component then loops to block 303 to start the next iteration. In block 310, the component outputs the ranking function.

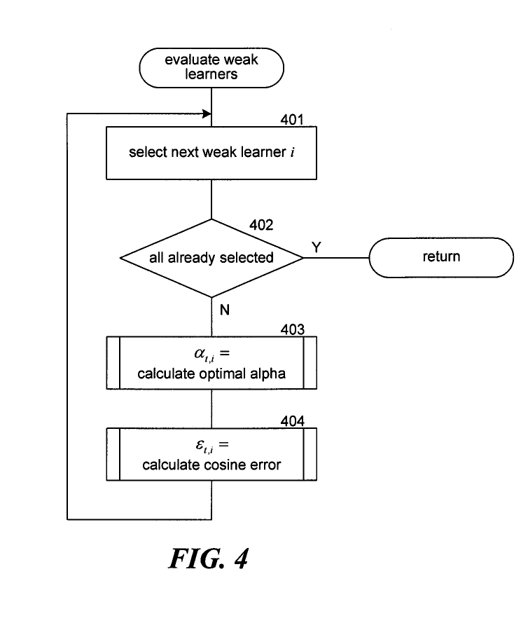

FIG. 4 is a flow diagram that illustrates the processing of the evaluate weak learners component of the ranking system in one embodiment. In block 401, the component selects the next candidate weak learner. In decision block 402, if all the candidate weak learners have already been selected, then the component returns, else the component continues at block 403. In block 403, the component invokes the calculate optimal alpha component to calculate the optimal combination weight for the selected weak learner. In block 404, the component invokes the calculate cosine error component to calculate the error assuming the selected weak learner is added to the ranking function generated so far. The component then loops to block 401 to select the next weak learner.

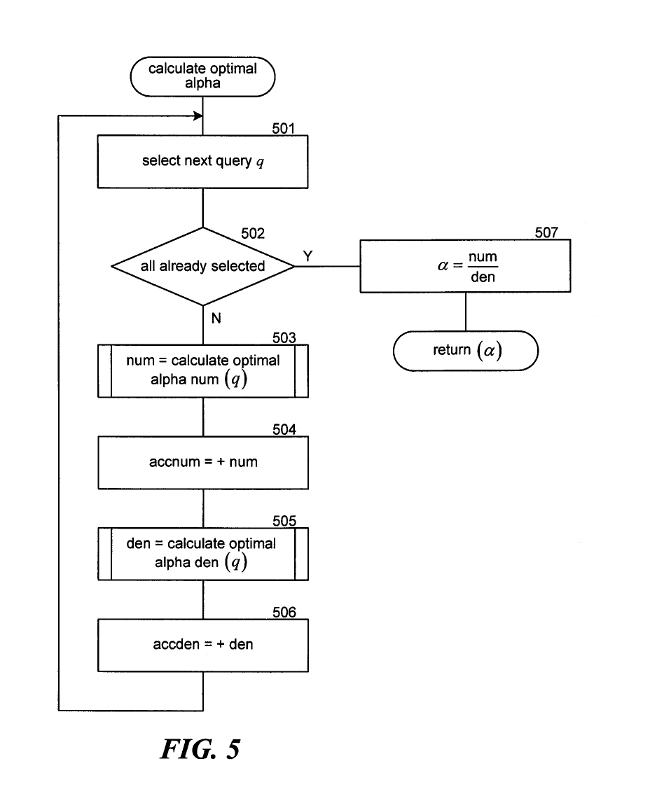

FIG. 5 is a flow diagram that illustrates the processing of the calculate optimal alpha component of the ranking system in one embodiment. The component implements the function represented by Equation 13 to calculate the combination weight for the passed weak learner. In block 501, the component selects the next query. In decision block 502, if all the queries have already been selected, then the component continues at block 507, else the component continues at block 503. In block 503, the component invokes a calculate optimal alpha num component to calculate the contribution of the selected query to the numerator of Equation 13. In block 504, the component accumulates the numerator. In block 505, the component invokes a calculate optimal alpha den component to calculate the contribution of the selected query to the denominator of Equation 13. In block 506, the component accumulates the denominator and then loops to block 501 to select the next query. In block 507, the component calculates the combination weight for the passed weak learner and then returns.

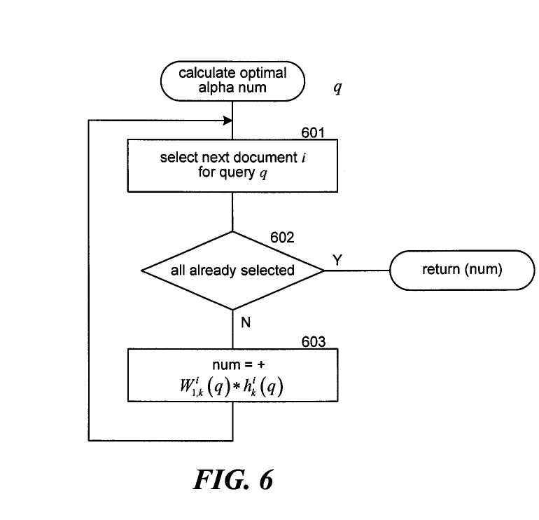

FIG. 6 is a flow diagram that illustrates the processing of the calculate optimal alpha num component of the ranking system in one embodiment. The component is passed a query and calculates its contribution to the numerator of Equation 13. In block 601, the component selects the next document for the passed query. In decision block 602, if all the documents for the passed query have already been selected, then the component returns the contribution to the numerator, else the component continues at block 603. In block 603, the component adds the contribution of the selected document to the contribution of the passed query to the numerator. The component then loops to block 601 to select the next document.

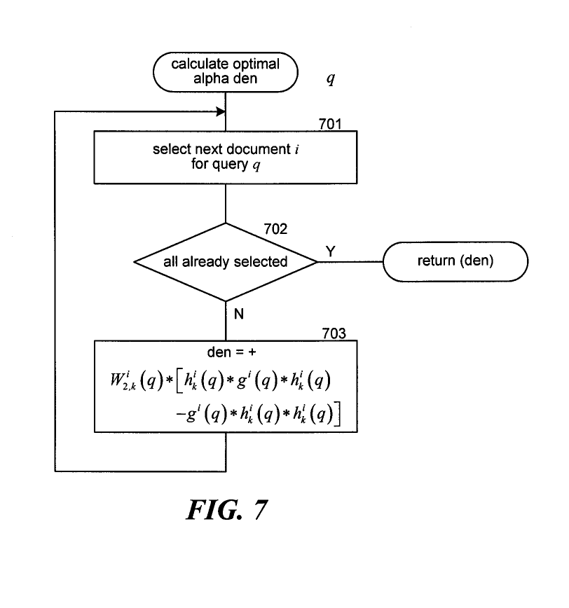

FIG. 7 is a flow diagram that illustrates the processing of the calculate optimal alpha den component of the ranking system in one embodiment. The component is passed a query and calculates its contribution to the denominator of Equation 13. In block 701, the component selects the next document for the selected query. In decision block 702, if all the documents have already been selected for the selected query, then the component returns the contribution to the denominator of the query, else the component continues at block 703. In block 703, the component adds the contribution of the selected document to the contribution to the denominator of the selected query and then loops to block 701 to select the next document.

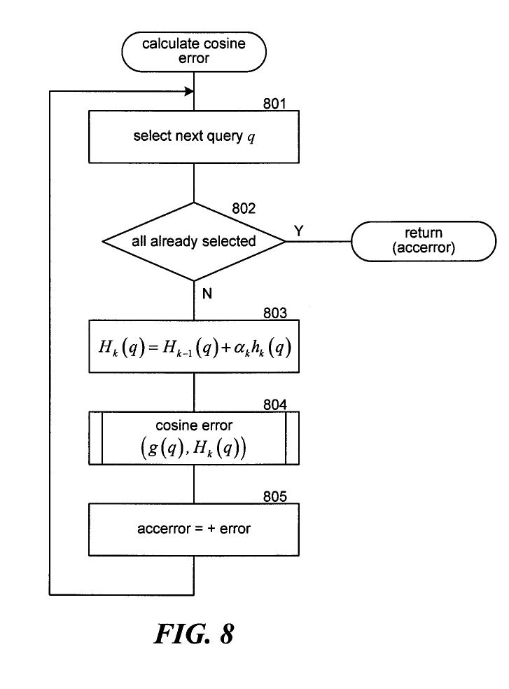

FIG. 8 is a flow diagram that illustrates the processing of the calculate cosine error component of the ranking system in one embodiment. The component loops selecting a query and aggregating the error for the selected query to the total error. In block 801, the component selects the next query. In decision block 802, if all the queries have already been selected, then the component returns the accumulated error, else the component continues to block 803. In block 803, the component calculates the calculated relevances for the documents of the selected query. In block 804, the component invokes a cosine error component to calculate the error for the selected query. In block 805, the component accumulates the total error. The component then loops to block 801 to select the next query.

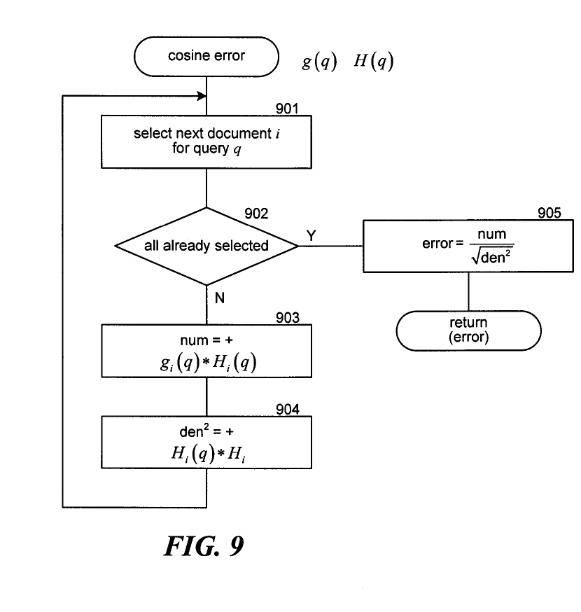

FIG. 9 is a flow diagram that illustrates the processing of the cosine error component of the ranking system in one embodiment. The component is passed actual relevances and calculated relevances for a query and calculates the error for the query. In block 901, the component selects the next document for the passed query. In decision block 902, if all the documents have already been selected, then the component continues at block 905, else the component continues at block 903. In block 903, the component adds the contribution of the selected query to the numerator. In block 904, the component adds the contribution of the selected query to the denominator. The component then loops to block 901 to select the next document. In block 905, the component calculates the error for the passed query and returns.

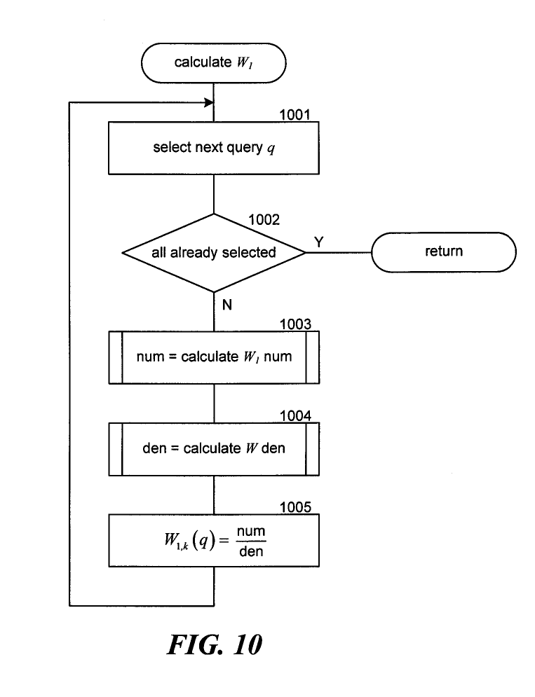

FIG. 10 is a flow diagram that illustrates the processing of the calculate W₁ component of the ranking system in one embodiment. The component implements the function of Equation 14 to calculate query weights for the next iteration. In block 1001, the component selects the next query. In decision block 1002, if all the queries have already been selected, then the component returns, else the component continues at block 1003. In block 1003, the component invokes a calculate W₁ num component to calculate a numerator for Equation 14. In block 1004, the component invokes the calculate W den component to calculate the denominator for Equation 14. In block 1005, the component calculates the W₁ query weight for the selected query and then loops to block 1001 to select the next query.

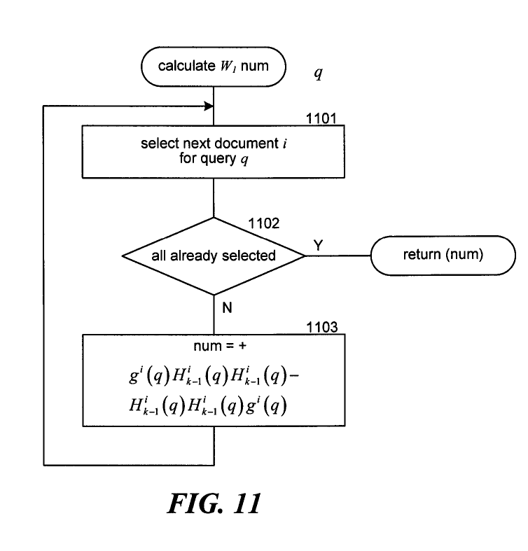

FIG. 11 is a flow diagram that illustrates the processing of the calculate W₁ num component of the ranking system in one embodiment. In block 1101, the component selects the next document for the passed query. In decision block 1102, if all the documents have already been selected, then the component returns the numerator for the passed query, else the component continues at block 1103. In block 1103, the component adds the contribution of the selected document to the numerator and then loops to block 1101 to select the next document.

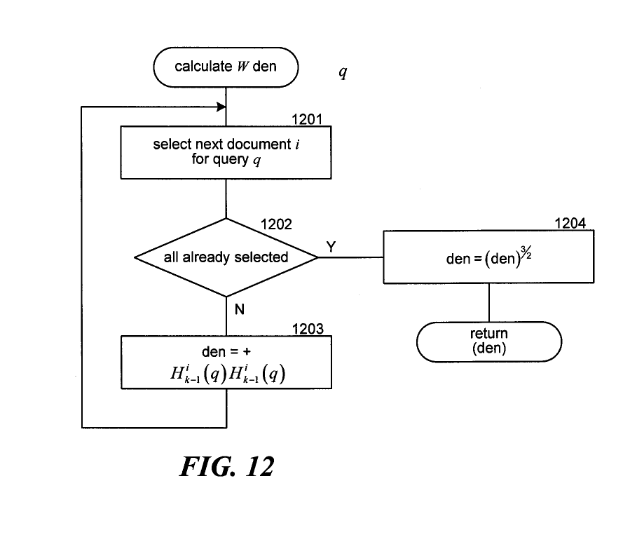

FIG. 12 is a flow diagram that illustrates the processing of the calculate W den component of the ranking system in one embodiment. In block 1201, the component selects the next document for the passed query. In decision block 1202, if all the documents have already been selected, then the component continues at block 1204, else the component continues at block 1203. In block 1203, the component aggregates the contribution of the selected document to the denominator and then loops to block 1201 to select the next document. In block 1204, the component calculates the final denominator and then returns.

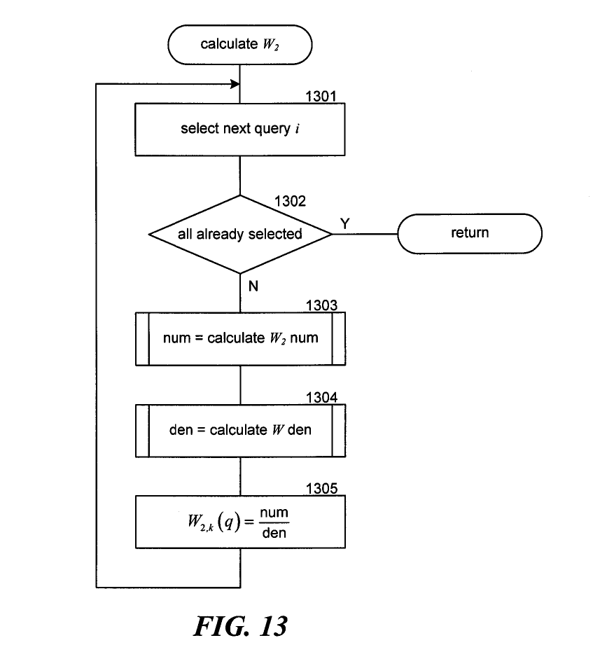

FIG. 13 is a flow diagram that illustrates the processing of the calculate W₂ component of the ranking system in one embodiment. The component implements the function of Equation 15. In block 1301, the component selects the next query. In decision block 1302, if all the queries have already been selected, then the component returns, else the component continues at block 1303. In block 1303, the component invokes the calculate W₂ num component to calculate the numerator for Equation 15. In block 1304, the component invokes the calculate W den component to calculate the denominator for Equation 15. In block 1305, the component calculates the W₂ query weight for the selected query and then loops to block 1301 to select the next query.

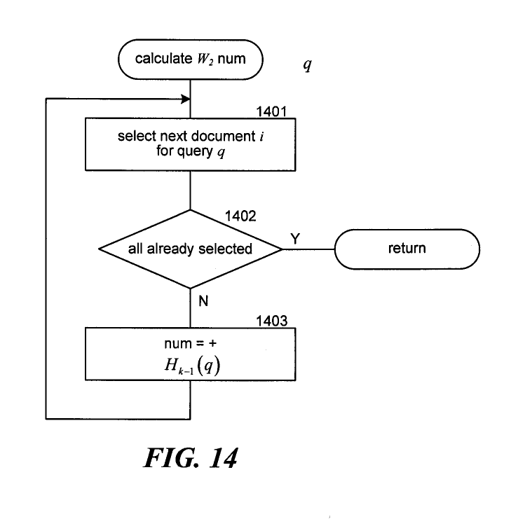

FIG. 14 is a flow diagram that illustrates the processing of the calculate W₂ num component of the ranking system in one embodiment. In block 1401, the component selects the next document for the passed query. In decision block 1402, if all the documents have already been selected, then the component returns, else the component continues at block 1403. In block 1403, the component adds the contribution of the selected document to the numerator and then loops to block 1401 to select the next document.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. The ranking system may be used to rank a variety of different types of documents. For example, the documents may be web pages returned as a search result by a search engine, scholarly articles returned by a journal publication system, records returned by a database system, news reports of a news wire service, and so on. The ranking system may be used to calculate the error between two different types of relevances for groups of documents in a collection of documents. For example, each group may correspond to a cluster of documents in the collection and the relevance of each document to its cluster may be calculated using different algorithms. The error calculated by the ranking system represents the difference in the algorithms. Accordingly, the invention is not limited except as by the appended claims.

I/We claim:

1. A computer system for generating a document ranking function, comprising:
a training store that contains, for each of a plurality of queries, features of documents corresponding to the query, and an actual relevance of each document to the query;
a error calculation component that calculates a normalized error between the actual relevances and calculated relevances of documents corresponding to a query; and
a training component that trains a ranking function using the normalized errors as calculated by the error calculation component to indicate accuracy of the ranking function in generating relevances of the documents to their corresponding queries.

2. The computer system of claim 1 wherein the normalized error for a query is independent of the number of documents corresponding to a query.

3. The computer system of claim 2 wherein the normalized error is represented as follows:
$$J ( g ( q ) , H ( q ) ) = - cos ( g ( q ) , H ( q ) ) = - \frac{g {( q )}^{T} H ( q )}{‖ g ( q ) ‖ ‖ H ( q ) ‖}$$
where J(g(q),H(q)) represents the normalized error for query q, g(q) represents a vector of actual relevances for the document corresponding to query q, H(q) represents a vector of calculated relevances for the document corresponding to query q, and ∥ ∥ is the L-2 norm of a vector.

4. The computer system of claim 2 wherein the normalized error is based on an angle between a vector representing the actual relevances and the calculated relevances as represented in an n(q)-dimensional space where n(q) is the number of documents corresponding to query q.

5. The computer system of claim 1 wherein the training component trains the ranking function using an adaptive boosting algorithm.

6. The computer system of claim 5 wherein the adaptive boosting algorithm selects at each iteration a weak learner that when combined with previously selected weak learners results in an aggregate normalized error that is smallest.

7. The computer system of claim 6 wherein the adaptive boosting algorithm calculates a contribution weight for each weak learner that indicates contribution of the relevances of that weak learner relative to the other weak learners of the ranking function.

8. The computer system of claim 5 wherein the adaptive boosting algorithm calculates a query weight that indicates the weight to be accorded to the actual relevances of each query when selecting the next weak learner.

9. A computer system for calculating an error between actual relevances and training relevances of groups of documents, comprising:
a group error calculation component that calculates an error between the actual relevances and calculated relevances of documents of the group, the error being independent of the number of documents in the group; and
an overall error calculation component that aggregates the errors of the groups into an overall error for the groups of documents.

10. The computer system of claim 9 wherein the calculated relevances are calculated by a ranking function that ranks the relevance of each document of a group to the group.

11. The computer system of claim 9 wherein a user provides the actual relevance of a document to a group.

12. The computer system of claim 9 wherein each group corresponds to a query and the documents of the group are from a search result of the query.

13. The computer system of claim 12 wherein the normalized error is represented as follows:
$$J ( g ( q ) , H ( q ) ) = - cos ( g ( q ) , H ( q ) ) = - \frac{g {( q )}^{T} H ( q )}{‖ g ( q ) ‖ ‖ H ( q ) ‖}$$
where J(g(q),H(q)) represents the normalized error for query q, g(q) represents a vector of actual relevances for the documents corresponding to query q, H(q) represents a vector of calculated relevances for the documents corresponding to query q, and ∥ ∥ is the L-2 norm of a vector.

14. The computer system of claim 12 wherein the normalized error is based on an angle between a vector representing the actual relevances and the calculated relevances as represented in an n(q)-dimensional space where n(q) is the number of documents corresponding to query q.

15. The computer system of claim 9 including a training component that learns a ranking function to rank relevance of documents to groups using an adaptive boosting algorithm that selects at each iteration a weak learner that when combined with previously selected weak learners results in an aggregate error that is smallest.

16. The computer system of claim 15 wherein the adaptive boosting algorithm calculates a combination weight for each weak learner that indicates contribution of the relevances of that weak learner relative to the other weak learners of the ranking function.

17. The computer system of claim 15 wherein the adaptive boosting algorithm calculates a group weight that indicates the weight to be accorded to the actual relevances of each group when selecting the next weak learner.

18. A computer system for ranking web pages, comprising:
a search store that contains a search result of a query conducted by a search engine service, the search result identifying web pages relevant to the query; and
a web page ranking component that ranks web pages of the search result based on relevance to the query, the web page ranking component having been trained using a normalized query-level error measurement.

19. The computer system of claim 18 wherein the web page ranking component has been trained using the normalized query-level error measurements to guide selection of weak learners for an adaptive boosting algorithm.

20. The computer system of claim 19 wherein the normalized query-level error is based on an angle between a vector representing actual relevances and calculated relevances of web pages to their corresponding query as represented in an n(q)-dimensional space where n(q) is the number of web pages corresponding to query q.
